(19) United States
(12) Patent Application Publication
(10) Pub. No.: US 2003/0064707 A1
(43) Pub. Date: Apr. 3, 2003

(54) Radio communication terminal

(76) Inventor: Tokuji Yoneyama, Tokyo (JP)

Correspondence Address: McGinn & Gibb, PLLC, Suite 200, 8321 Old Courthouse Road, Vienna, VA, 22182-3817, US

(21) Appl. No.: 10/137,362

(22) Filed: May 3, 2002

(30) Foreign Application Priority Data
Sep. 28, 2001 (JP) 2001-299019

(51) Int. Cl. H04M 11/10

(52) U.S. Cl. 455/412; 455/413

(57) ABSTRACT

By automatically registering a related key word when a received message is displayed, past e-mail messages related to the received message can be selected by single-clicking.

When a portable telephone receives an e-mail message, the received message is displayed on a display portion. A registering means automatically registers in a storage portion a key word from the received message displayed on the display portion. When a user searches for past sent messages and received messages related to the received message displayed on the display portion, the searching means automatically searches for the key word registered in the storage portion. Hence, desired messages can be searched for and retrieved from past e-mail messages simply by single clicking a software button displayed on a screen. The retrieved messages are displayed on the display portion by a retrieved message display controlling means. The display can be switched between the received message and the retrieved messages simply by single-clicking a software button.

### BACKGROUND OF THE INVENTION

1. Field of the Invention

The present invention relates to a radio communication terminal such as a portable telephone provided with a function for automatically searching for a desired electronic mail (e-mail) message, and particularly relates to a radio communication terminal such as a portable telephone provided with a function for automatically searching for and displaying desired e-mail messages from past sent and received messages related to a received e-mail message.

2. Description of the Related Art

In recent years, besides communication by voice, communication by email has become popular on portable telephones. Because e-mail messages of this kind can be sent irrespective of the recipient's circumstances and the recipient can also open the e-mail message and get information when convenient, it can be said to be a communication means which takes the other person's standpoint into consideration. In an e-mail communication means of this kind, a lot of received messages may be opened sequentially at once, and e-mail messages sent or received in the past may be searched for and displayed in order to access information related to an e-mail message just received. When displaying past e-mail messages in this manner, a search for the required e-mail messages is performed by inputting key words.

However, in current portable telephones, it is not easy to view past sent messages and received messages showing background information up to the received e-mail message when that received e-mail message is displayed. Specifically, in order to display a past e-mail message that a user wants to view, the displayed contents of the currently-displayed received message must be closed temporarily, an outbox or an inbox must be displayed, and then the email message in question must be selected. Hence, because the operation extends over a plurality of steps, operational complications are unavoidable. Furthermore, when searching for the required past e-mail message, the user must input a key word to perform the search, then, after referring to the past email message, display the received message once again by a plurality of operations before performing processes such as replying or forwarding.

In order to solve such problems, Japanese Patent Laid-Open No. 2001-22789, for example, discloses a technique for easily performing a search for a desired e-mail message from a plurality of e-mail messages. According to this technique, if search criteria such as chronological order, sender's name search, free word search, etc., are set, a desired e-mail message meeting those search criteria can be easily searched for and displayed. However, in this technique, the search must also be performed by giving the search criteria step-by-step to narrow down the search results by selecting the sender's name, inputting free words, etc. Consequently, because an operation involving a plurality of steps must be performed until the desired e-mail message is found, poor search efficiency is still not solved.

### SUMMARY OF THE INVENTION

The present invention is made in view of circumstances of this kind and an object thereof is to provide a radio communication terminal such as a portable telephone enabling past e-mail messages related to a displayed received message to be selected by single-clicking by automatically registering related key words when the received message is displayed.

In order to solve the above problems, according to one aspect of the present invention, there is provided a radio communication terminal having a function for searching for and displaying a desired e-mail message from past e-mail messages related to a received e-mail message, wherein

the radio communication terminal includes:

a storage means for storing a key word related to a currently-displayed received e-mail message;

a message search means for searching for and retrieving an e-mail message related to the currently-displayed e-mail message from past e-mail messages based on the key word stored in the storage means; and

a display controlling means for switching and displaying the received email message and the retrieved e-mail message when a predetermined button is single-clicked.

With the radio communication terminal according to the present invention, when the most-recent received message is displayed, a key word from that received message is immediately stored in the storage means. Then, the message search means searches for past e-mail messages related to the currently-displayed received message based on the key word stored in the storage means, extracts a retrieved e-mail message, and displays it on the screen. Hence, past e-mail messages related to the currently-open received message can be easily searched for with the contents of the received message displayed, and the most-recent received message and the past retrieved e-mail message can be switched freely and displayed by a single-clicking operation.

The radio communication terminal may further include a registering means for registering in the storage means the key word related to the currently-displayed e-mail message.

With the radio communication terminal according to the present invention, if the registering means registers a key word related to the currently-displayed e-mail message in the storage means, the searching means searches for and retrieves an e-mail message (or messages) related to the currently-displayed e-mail message from among past sent messages, or received messages, or sent and received messages, based on the key word registered in the storage means. Moreover, in the preferred embodiment, the retrieved message display controlling means displays the retrieved e-mail message on a screen. Hence, the user can display the retrieved e-mail message, or display the most-recent received message simply by single-clicking a software button on the screen. Thus, in the radio communication terminal according to the present invention, even if the user does not expressly input a key word for the currently-displayed received message (for example, a telephone number, an address, etc.), a key word is registered automatically by the registering means, and that key word is searched automatically by the searching means. Consequently, messages desired by the user can be retrieved from among sent messages and received messages and displayed instantly, enabling a convenient portable radio terminal such as a portable telephone to be achieved.

In the radio communication terminal according to the present invention, the display controlling means may alternatively select and display past sent messages, past received messages, or past sent and received messages according to a user setting.

With the radio communication terminal according to the present invention, when opening past e-mail messages with the most-recent received message displayed, the user can meet various intended uses by optionally selecting whether to open past sent messages, or to open past received messages, or to view all of the past sent and received messages in order to view both sides of the exchange.

In the radio communication terminal according to the present invention, the display controlling means may further perform switching and displaying of the retrieved e-mail message and e-mail messages preceding or following the retrieved e-mail message by single-clicking the predetermined button.

With the radio communication terminal according to the present invention, when the contents of a retrieved e-mail message are displayed on the screen, it is possible to switch the display to the next retrieved e-mail message or to the retrieved e-mail message immediately before by single-clicking.

In the radio communication terminal according to the present invention, the display controlling means may optionally change a font color or a background color of a sent message and a received message.

With the radio communication terminal according to the present invention, the displayed font color and background color of the retrieved sent messages and received messages can be changed to make them stand out more.

### BRIEF DESCRIPTION OF THE DRAWINGS

FIG. 1 is a block diagram showing a hardware construction of a portable telephone according to the present invention;

FIG. 2 is a structural diagram of a message search processing means 2a provided in a control portion 2 shown in FIG. 1;

FIG. 3 is a flowchart showing the flow of an e-mail message search process in the portable telephone shown in FIG. 1;

FIGS. 4A to 4B are display screens displayed on a display portion of the portable telephone during the search process, FIG. 4A being a most-recent received message display screen, FIG. 4B being a message search type designation screen, FIG. 4C being a sent message list display screen, and FIG. 4D being a retrieved sent message display screen;

FIGS. 5A to 5C are message list display screens displayed depending on each designation of the message search type designation screen in FIG. 4B, FIG. 5A being a sent message list display screen, FIG. 5B being a received message list display screen, and FIG. 5C being a sent and received message list display screen; and

FIG. 6 is a screen transition diagram for a message search function according to the present invention.

### DETAILED DESCRIPTION OF THE PREFERRED EMBODIMENT

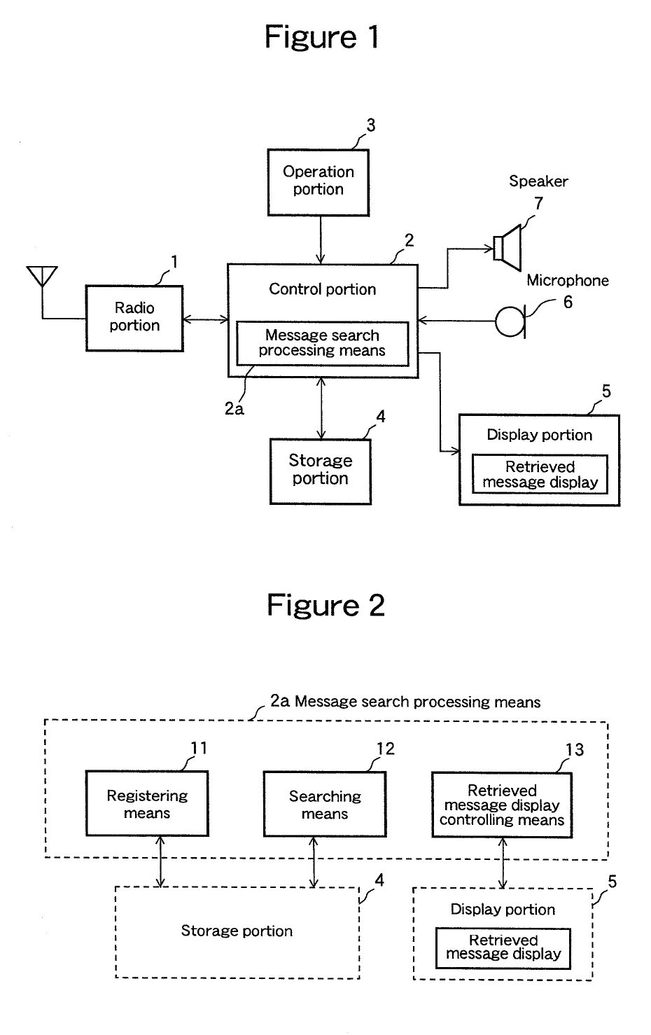

A preferred embodiment of the radio communication terminal according to the present invention will now be explained using the drawings, presenting a portable telephone as an example. FIG. 1 is a block diagram showing a hardware configuration of a portable telephone according to the present invention. As shown in FIG. 1, the basic construction of the portable telephone according to the present invention is generally similar to conventional portable telephones, differing from the conventional examples only in that a message search processing means 2a is provided in a control portion 2.

In other words, a portable telephone according to the present invention is constituted by: a radio portion 1 for transmitting and receiving radio signals; a control portion 2 for performing signal processing accompanying a call, display processing of e-mail messages, etc., and controlling singing, etc., the control portion 2 being provided with a message search processing means 2a for performing a search process on e-mail messages; an operation portion 3 via which a user inputs character data; a storage portion 4 for storing processing programs in the control portion 2, contact list data, search key words from email messages, etc.; a display portion 5 for displaying input character data, received messages, retrieved e-mail messages (retrieved messages), etc.; a microphone 6 for converting sound input into electrical signals; and a speaker 7 for converting electrical signals into sound.

FIG. 2 is a structural diagram of the message search processing means 2a provided in the control portion 2 shown in FIG. 1. Specifically, the message search processing means 2a is provided with: a registering means 11 for automatically registering in the storage portion 4 key words from an email message displayed by the display portion 5; a searching means 12 for automatically retrieving retrieved messages from past sent messages or received messages based on the key words registered in the storage portion 4; and a retrieved message display controlling means 13 for displaying retrieved past e-mail messages (the retrieved messages) on the screen of the display portion 5.

Next, the operation of a portable telephone constructed as shown in FIGS. 1 and 2 will be generally explained. First, when the portable telephone receives an e-mail message, that e-mail message is displayed on the display portion 5. Then, the registering means 11 automatically registers in the storage portion 4 key words from the e-mail message displayed on the display portion 5. If the user wants to search for past sent messages and received messages related to the e-mail message displayed on the display portion 5, the searching means 12 automatically searches for the key words registered in the storage portion 4. Hence, the desired messages can be searched for and retrieved from past e-mail messages simply by single-clicking a software button displayed on the screen. Then, the retrieved messages are displayed on the display portion 5 by the retrieved message display controlling means 13. Furthermore, the received e-mail message and the retrieved messages can be alternately cycled and displayed simply by single-clicking the software button. In other words, using the portable telephone according to the present invention, by automatically registering related key words when the received message is displayed, past e-mail messages related to the displayed received message can be selected by single-clicking.

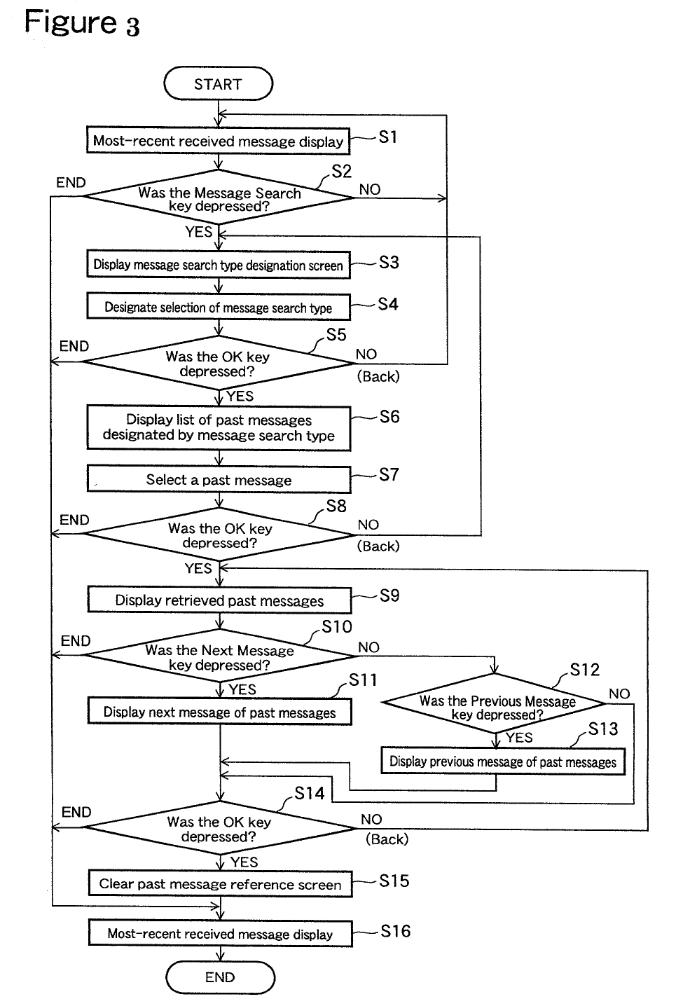

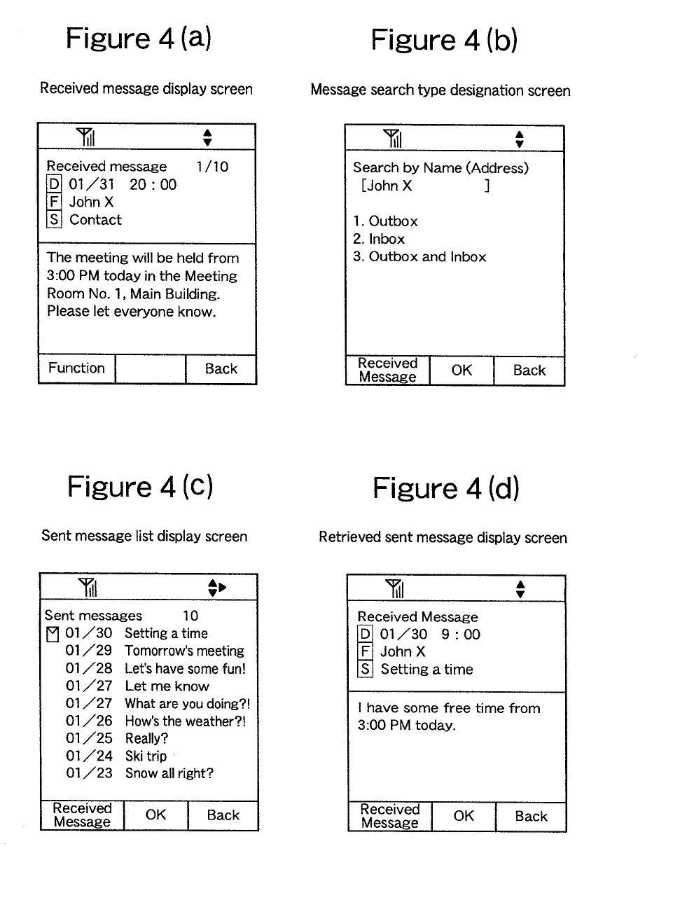

FIG. 3 is a flowchart showing the flow of an e-mail message search process in the portable telephone shown in FIG. 1. FIGS. 4A to 4B are display screens displayed on the display portion of the portable telephone during the search process, FIG. 4A being a most-recent received message display screen, FIG. 4B being a message search type designation screen, FIG. 4C being a sent message list display screen, and FIG. 4D being a retrieved sent message display screen. Consequently, the flow of the e-mail message search process of the portable telephone according to the present invention will be explained in detail following the flowchart in FIG. 3 while referring to the specific display examples shown in FIG. 4.

First, when the portable telephone receives e-mail messages, the most-recently received e-mail message (the most-recent received message) is displayed on the screen by a generally-provided e-mail message receiving function (Step S1). For example, a screen such as the received message display screen in FIG. 4A is displayed. Here, when the user wishes to refer to past sent messages and received messages related to the most-recent received message displayed as in FIG. 4A, the user depresses a key for searching for the relevant past e-mail messages (hereinafter “<Message Search> key”). Consequently, the message search processing means 2a of the control portion 2 decides whether the <Message Search> key was depressed (Step S2).

If the <Message Search> key has been depressed (YES at Step S2), a message search type designation screen is displayed for selecting the type of e-mail message to search for (Step S3). For example, for “Search by Name [John X]”, as in the message search type designation screen in FIG. 4B, a selection screen is displayed for selecting one of:

1. a list of past sent messages (i.e., an outbox);

2. a list of past received messages (i.e., an inbox); or

3. lists of past sent and received messages (i.e., the outbox and the inbox).

Moreover, if the <Message Search> key has not been depressed at Step S2 (NO at Step S2), the process returns to Step S1, remaining at a most-recent received message display screen such as that in FIG. 4A.

Returning to Step S3, the full name or address of the sender of the currently-displayed received message is displayed automatically in “Search by Name” in the message search type designation screen of the kind shown in FIG. 4B (i.e., the name or address on the received message display screen in FIG. 4A) under the control of the retrieved message display controlling means 13. In addition, key words from the received message are automatically registered in the storage portion 4 by the registering means 11. Consequently, because the search for the retrieved messages is performed automatically using the key words registered in the storage portion 4 (details will be described in the steps described below), the search can be conducted even if the user does not designate the key words expressly.

Next, the user designates the message search type by selection (Step S4) to decide which of the following in the message search type designation screen in FIG. 4B to designate for searching:

1. Outbox;

2. Inbox; or

3. Outbox and Inbox.

Then, after the message search type in the message search type designation screen in FIG. 4B is selected, a decision is made as to whether a key indicating selection completion (hereinafter “<OK> key”) has been depressed (Step S5). Here, if the <OK> key has been depressed (YES at Step S5), a list of past e-mail messages of the type designated as the message search type in Step S4 is displayed on the screen (Step S6). For example, if the outbox is designated in FIG. 4B, a list of past sent messages such as that shown in FIG. 4C is displayed on the screen. Moreover, in Step S5, if a <Back> key is depressed without the <OK> key being depressed at the message search type designation screen shown in FIG. 4B (NO at Step S5), the process returns to Step S1, displaying a screen showing the most-recently received e-mail message, as in FIG. 4A.

FIG. 4C is an example of a past e-mail message list for a designated type displayed in Step S6 described above. More specifically, FIG. 4C shows an example in which a list of past sent messages is displayed on the screen when “Outbox” has been designated by selection on the designation screen in FIG. 4B.

Next, the user selects the sent message to be opened from among the list of past e-mail messages shown in FIG. 4C (i.e., the list of sent messages) (Step S7). Then, a decision is made as to whether the <OK> key has been depressed (Step S8). More specifically, after the user selects a sent message to be opened on the sent message list display screen in FIG. 4C (the sent message dated “01/30”, for example), the portable telephone decides whether the <OK> key has been depressed.

Here, if the <OK> key has been depressed (YES at Step S8), the past message to be opened is displayed (Step S9). For example, a screen showing the retrieved sent message sent “01/30” is displayed, as in FIG. 4D. Moreover, if the <Back> key is depressed at Step S8 without the <OK> key being depressed on the sent message list display screen in FIG. 4C (NO at Step S8), the process returns to Step S3, displaying a message search type designation screen such as that shown in FIG. 4B.

Next, when a retrieved past message such as that in FIG. 4D (the sent message dated “01/30”, for example) at is displayed Step S9, the portable telephone decides whether a <Next Message> key has been depressed (Step S10), and if the <Next Message> key has been depressed (YES at Step S10), a past message following the retrieved past message displayed at Step S9 is displayed (Step S11). The portable telephone also decides whether a <Previous Message> key has been depressed without the <Next Message>key being depressed (Step S12), and if the <Previous Message> key has been depressed (YES at Step S12), a past message preceding the retrieved past message displayed at Step S9 is displayed (Step S13).

Hence, when the user wishes to refer to sent messages other than the past sent message displayed in FIG. 4D, a sent message (or a received message) following the currently-displayed past message can be displayed by depressing the <Next Message> key, and a sent message (or a received message) earlier than the currently-displayed past message can be displayed by depressing the <Previous Message> key. Consequently, preceding and following e-mail messages can be alternately opened and referred to with a single key stroke without having to deliberately close the currently-open received message once and reselect the e-mail message the user wishes to refer to.

Hence, when a retrieved past message such as in FIG. 4D is being referred to, the portable telephone decides whether the <OK> key has been depressed (Step S14), and if the <OK> key has been depressed (YES at Step S14), the past message referencing process is terminated, the past message reference screen shown in FIG. 4D is cleared (Step S15), and the screen is returned to the initially displayed most-recent received message display screen shown in FIG. 4A (Step S16), completing the process.

Moreover, at Step S14, if the <Back> key is depressed without the <OK> key being depressed at the retrieved sent message display screen in FIG. 4D (NO at Step S14), the process returns to Step S9, displaying a sent message list display screen such as that shown in FIG. 4C.

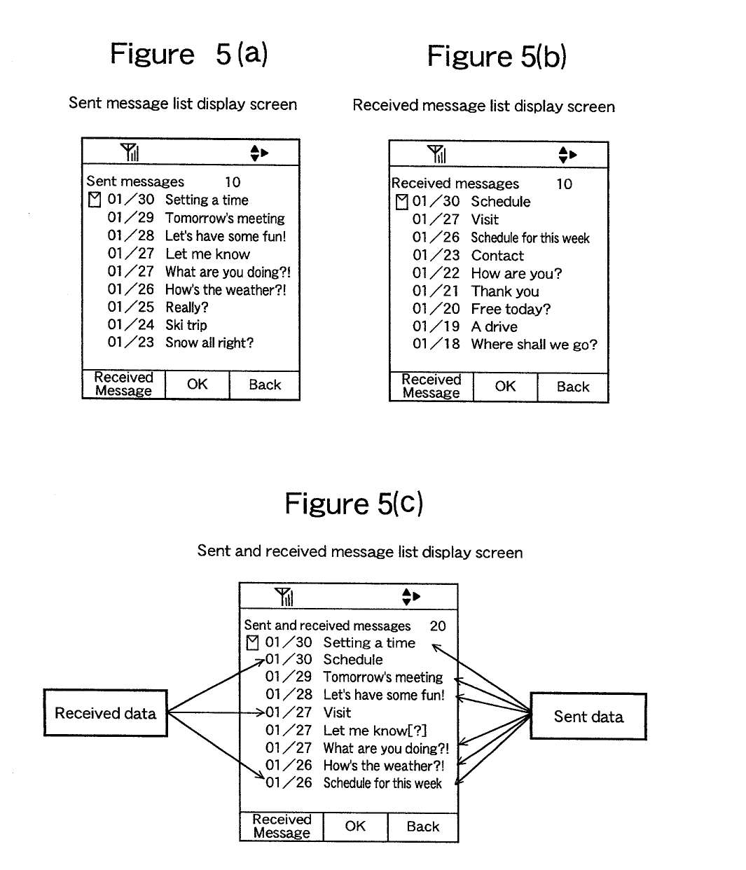

FIGS. 5A to 5C are message list display screens when each message search type is designated at Step S4 of the flowchart in FIG. 3, FIG. 5A being a sent message list display screen, FIG. 5B being a received message list display screen, and FIG. 5C being a sent and received message list display screen. In other words, FIGS. 5A to 5C are message list display screens displayed depending on each designation of the message search type designation screen in FIG. 4B. Specifically, when “Outbox” is designated in FIG. 4B, the “sent message list display screen” in FIG. 5A is displayed, when “Inbox” is designated in FIG. 4B, the “received message list display screen” in FIG. 5B is displayed, and when “Outbox and Inbox” is designated in FIG. 4B, the “sent and received message list display screen” in FIG. 5C is displayed.

Moreover, methods for returning to the received message screen in FIG. 4A, which was the initially-displayed screen, from each of the screens displayed after displaying the received message screen shown in FIG. 4A, include going back one screen at a time using a C key, which is a software key displayed on the screen (<Back>), or jumping back directly using an A key (<Received Message>). It is also possible to copy, cut, paste, etc., the displayed contents while the sent message or received message screens are displayed.

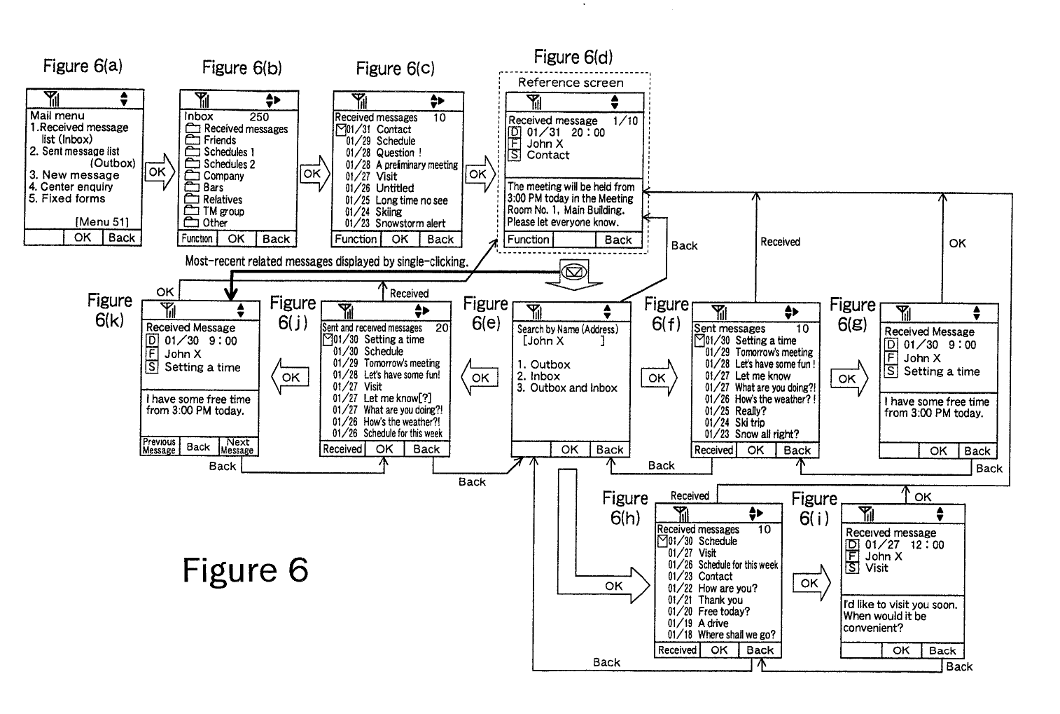

FIG. 6 is a screen transition diagram for a message search function according to the present invention. More specifically, this diagram shows transitional states of the screen in which the most-recent received message is displayed as a reference screen, and past sent messages and received messages relating to the currently-displayed subject are selected and displayed by single-clicking a mail key at each of the screens.

First, to display an e-mail message, an inbox screen (b) is displayed by selecting “Received message list (Inbox)” on a mail menu screen (a), and pressing <OK>. In addition, “Received messages” (c) is displayed by selecting “Received messages” and pressing <OK>, and the reference screen (d), being the most-recent received message, is displayed by selecting the received date “01/31” and pressing <OK>. Operation up to this point is the same as for a conventional portable telephone.

In the portable telephone according to the present invention, in order to access related information concerning the reference screen (d), the contents of related sent messages and received messages can be displayed by single-clicking. More specifically, a past sent message list display screen (f) is displayed by selecting “Outbox” by means of the message search type designation screen (e) and pressing <OK>, and the retrieved sent message display screen (g) can be displayed by selecting the sent date “01/30”, for example, and pressing <OK>. Furthermore, by <Back>from this screen (g), the user can return to the previous screen (f), and by pressing <OK>from this screen (g), the user can jump to the reference screen (d).

Similarly, a past received message list display screen (h) is displayed by selecting “Inbox” by means of the message search type designation screen (e) and pressing <OK>, and a retrieved received message display screen (i) can be displayed by selecting the received date “01/27”, for example, and pressing <OK>. Furthermore, by pressing <Back>from this screen (i), the user can return to the previous screen (h), and by pressing <OK>from this screen (i), the user can jump to the reference screen (d).

Similarly again, a past sent and received message list display screen (j) is displayed by selecting “Outbox and Inbox” by means of the message search type designation screen (e) and pressing <OK>, and a retrieved sent and received message display screen (k) can be displayed by selecting the sent or received date “01/30”, for example, and pressing <OK>. Furthermore, by pressing <Back>from this screen (k), the user can return to the previous screen (j). In addition, by pressing <Previous Message>, the user can move to the screen of the previous message on the related message list screen (j) by single-clicking, and by pressing <Next Message>, the user can move to the screen of the next message on the related message list screen (j) by single-clicking.

Hence, using the portable telephone according to the present invention, when the received message display screen which is the reference screen is displayed, past sent and received messages relating to the currently-displayed subject can be displayed selectively by single-clicking the desired message keys. In other words, the contents of past related messages can be displayed by single-clicking by selecting a related message function for the currently-displayed most-recent message. Moreover, although it is not single-clicking when the related message is selected from the menu screen and opened, it is possible to move to the desired screen by single-clicking if the related message function is selected on each of the displayed screens.

Furthermore, using the portable telephone according to the present invention, when a related message is displayed, a message preceding or following the related message can be displayed by single-clicking, and when the related message is displayed it is possible to return to display an original reference screen (the most-recent received message) by single-clicking. In addition, it is also possible to change the font color and the background color for displaying the retrieved sent messages and received messages to make them stand out more. Furthermore, the search key words are automatically identified, but the user may also set desired key words in advance. In addition, when displaying related sent and received messages, the user may also select either sent or received messages in advance. Furthermore, the contents of the related messages are displayed by single-clicking, but a related message list may also be displayed if the user so chooses.

The preferred embodiment described above is an example for explaining the present invention, but the present invention is not limited to the above embodiment and various kinds of variations are possible within the general scope of the invention. For example, in the above embodiment, a method for retrieving related messages when sending and receiving e-mail messages by portable telephone was described, but it goes without saying that the present invention is not limited to a portable telephone and can be applied to a method for retrieving related messages when sending and receiving e-mail messages on any portable radio terminal such as a mobile terminal, etc.

As explained above, with the portable radio terminal according to the present invention, since the message search means of the portable radio terminal sets the key word automatically when the received message is displayed, the user can easily retrieve and display past e-mail messages. Consequently, the amount of time and number of operations required to find and retrieve e-mail messages can be reduced, significantly improving operability of the portable radio terminal. Furthermore, with the portable radio terminal according to the present invention, when searching for past e-mail messages related to the currently-displayed most-recent e-mail message, because it is possible to select only past sent messages, or to select only past received messages, or to select both past sent and received messages depending on the intended use, operability for the intended use is improved significantly. In addition, because it is possible to display subsequent related messages or preceding related messages by a single key stroke without having to going back to a submenu for the related messages after retrieval, the search operation can be shortened, significantly improving operability.

In other words, according to the present invention, when the received message is displayed, the registering means of the portable radio terminal automatically registers a key word from e-mail messages from the user to another person or from the other person to the user related to the open e-mail message. Thus, the user can easily search and retrieve messages by using the registered key word. Consequently, it is possible to provide a portable radio terminal such as a portable telephone having a message search function in which past messages related to a most-recent e-mail message can be displayed and compared.

What is claimed is:

1. A radio communication terminal having a function for searching for and displaying a desired e-mail message from past e-mail messages related to a received e-mail message, wherein
said radio communication terminal comprises:
a storage means for storing a key word related to a currently-displayed received e-mail message;
a message search means for searching for and retrieving an e-mail message related to said currently-displayed e-mail message from past e-mail messages based on said key word stored in said storage means; and
a display controlling means for switching and displaying said received e-mail message and said retrieved e-mail message when a predetermined button is single-clicked.

2. The radio communication terminal according to claim 1 further comprising a registering means for registering in said storage means said key word related to said currently-displayed e-mail message.

3. The radio communication terminal according to claim 1 wherein said display controlling means alternatively selects and displays past sent messages, past received messages, or past sent and received messages according to a user setting.

4. The radio communication terminal according to claim 1 wherein said display controlling means further performs switching and displaying of said retrieved e-mail message and e-mail messages preceding or following said retrieved e-mail message by single-clicking said predetermined button.

5. The radio communication terminal according to claim 1 wherein said display controlling means optionally changes a font color or a background color of a sent message and a received message.
